(19) United States
(12) Patent Application Publication
(10) Pub. No.: US 2009/0037480 A1
(43) Pub. Date: Feb. 5, 2009

(54) OPTIMIZATION OF TRACE OUTPUT TIMING BASED ON DISK OPERATING CONDITIONS AND TRANSACTION CHARACTERISTIC

(75) Inventors: Takashi ENOMOTO, Kanagawa-ken (JP); Yohichi HATTORI, Kanagawa-ken (JP); Taro KAMIKI, Kanagawa-ken (JP)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 11/831,624

(22) Filed: Jul. 31, 2007

(51) Int. Cl. G06F 17/30

(52) U.S. Cl. 707/200; 707/E17.001

(57) ABSTRACT

A method, system and computer product for managing data write timing. The method includes selecting a policy composed of optimizing limits, inserting the selected policy into a score algorithm, running the score algorithm in response to a request to write data to determine a score, and writing the data to a file when the score is within the optimizing limits.

### FIELD OF THE INVENTION

System and method for the outputting of traces (or logs) in a client-server system with transaction characteristics.

### BACKGROUND OF THE INVENTION

Server/client-type systems are well known for performing a wide range of applications, e.g., transaction processing such as deposit/withdraw processing in a bank. It is particularly advantageous for these systems utilize data known as “traces” for each transaction, because they become important data at the time of debugging or failure.

Traces are generally output either immediately or placed into a buffer and output when the buffer is full. However, it has been found if traces are output at all times, they influence the performance.

Generally, traces are unloaded to a file at regular intervals or in accordance with a full buffer. However, if a peak of processing for requests from clients and trace output concur with each other, an effect such as a reduction in response to clients can result. There is a challenge as to how traces are output without putting loads on requests from clients.

It is known to update a trace acquisition level on the basis of a use of measured resources. For example, if the measured resource use situation is low, all levels of traces can be allowed to output, whereas, if the measured resource use situation changes to high, trace acquisition level will be updated. In this regard, only important traces will be allowed to output, and traces considered not important traces will be abandoned. However, as traces can contain important data at the time of debugging or failure, it is not advantageous to abandon traces.

### SUMMARY OF THE INVENTION

According to an aspect of the invention, a method for managing data write timing includes selecting a policy composed of optimizing limits, inserting the selected policy into a score algorithm, running the score algorithm in response to a request to write data to determine a score, and writing the data to a file when the score is within the optimizing limits.

In accordance with another aspect of the invention, a system for managing data write timing includes a policy storage unit structured and arranged to store optimizing limits, a log/trace scheduler coupled to the policy storage unit and comprising a score algorithm, the log/trace scheduler structured and arranged to receive a write data request from an application, and at least one of a logger or tracer coupled to receive from the log/trace schedule an authorization to write the data. The log/trace scheduler authorizes the writing of data when a score from the score algorithm is within the optimizing limits.

According to still another aspect of the invention, a computer program product includes a computer usable medium having readable program code embodied in the medium and including at least one component to receive optimizing limits of a policy, insert the optimizing limits into a score algorithm, run the score algorithm in response to a request to write data to determine a score, and write the data to a file when the score is within the optimizing limits.

### BRIEF DESCRIPTION OF THE DRAWINGS

FIG. 1 illustrates a system for performing a write output optimization method according to the invention;

FIG. 2 illustrates a flow diagram of a score algorithm utilizing the policy according to the invention;

FIG. 3 illustrates a diagram for adjusting the score according to a disk utilization rate;

FIG. 4 illustrates a flow diagram for adjusting the score according to transaction scores for all transactions;

FIG. 5 illustrates a table for transaction scores managed by a transaction manager based on an average; and

FIG. 6 illustrates a table for transaction scores managed by the transaction manager based on set input values.

### DETAILED DESCRIPTION OF EMBODIMENTS OF THE INVENTION

The invention is directed to a system for optimizing the outputting of all levels of traces. The system can be a client-server system with transaction characteristics.

Moreover, the invention improves the efficiency of known trace outputting procedures by storing traces in a memory and unloading the traces to a file by a trigger or by buffering traces in binary form, with no consideration to output timing.

According to an embodiment of the invention, optimum output timing can be estimated on the basis of a log/trace output determination policy [hereinafter referred to as “policy”], for example, from disk I/O conditions, the number of transactions during operation, weights (scores) for the types of transactions, and a history. The traces are output according to the estimated optimum output timing.

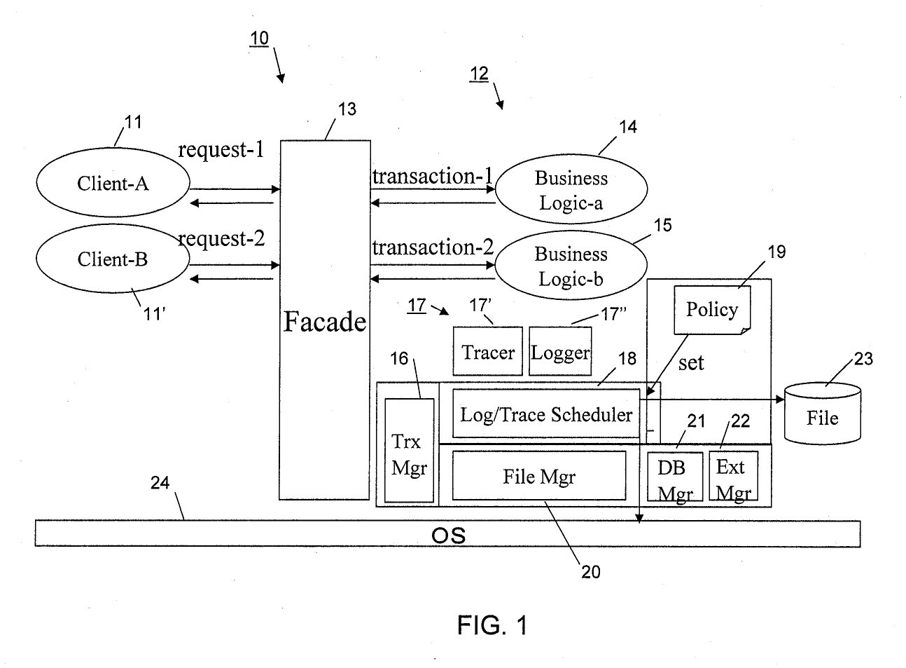

FIG. 1 illustrates an exemplary configuration of a system 10 for carrying out the instant invention. System 10 can include a computer infrastructure or architecture 12 to perform the processes described herein. In particular, the computer infrastructure may include a computing device of a management system in order to optimize the write timing of traces or logs to a file in accordance with the invention. The computing devices can include processors, memory, an input/output (I/O) interface, and a bus. The memory can include local memory employed during actual execution of program code, bulk storage, and cache memories which provide temporary storage of at least some program code in order to reduce the number of times code must be retrieved from bulk storage during execution. Further, the computing device can be in communication with an external I/O device/resource, such as keyboards, displays, pointing devices, etc., and a storage system.

It is noted the computer infrastructure is only illustrative of various types of computer infrastructures for implementing the invention. For example, in embodiments, the computer infrastructure can include two or more computing devices (e.g., a server cluster) that communicate over any type of communications link, such as a network, a shared memory, or the like, to perform the process described herein. Further, while performing the processes described herein, one or more computing devices in the computer infrastructure can communicate with one or more other computing devices external to computer infrastructure using any type of communications link. The communications link can include any combination of wired and/or wireless links; any combination of one or more types of networks (e.g., the Internet, a wide area network, a local area network, a virtual private network, etc.); and/or utilize any combination of transmission techniques and protocols.

System 10 can be, e.g., a client/server system directed to telephone banking or a call center, and in the exemplary embodiment of FIG. 1 can be directed to a financial institution online system, which can have certain transaction characteristics, such as deposits, withdrawals, and transfers of a financial institution. Other transaction characteristics can include number of file input/output, elapsed time of file input/output, number of database input/output, elapsed time of database input/output, number of external call, elapsed time of external call, etc. While the exemplary embodiment is directed to a financial institution online system, it is understood that other applications can be performed by the system according to the invention, e.g., a capital settlement system with external connection, i.e., domestic exchange, etc., a reservation system, i.e., airline ticket reservation, movie theater seat reservation, ticket reservation, etc., and/or general electronic commerce.

By way of example, client A 11 and client B 11′ can be connected to the architecture 12 through facade 13. Client A 11 and client B 11′ can pass requests to facade 13 via a suitable input/output interface, e.g., a data input device, such as a computer, PDA, wireless device, etc. Moreover, architecture 12 can include an internal database and/or can access an external database to store application data, such as customer information, account information, transaction information, etc. Further, architecture 12 can access the business logic associated with client requests. More particularly, a request by a client to facade 13 activates a specific transaction, e.g., a deposit, withdrawal, etc., which may start and end at facade 13 and may access a specified at least one of the stored business logic 14, 15. By way of example, facade 13 can be implemented by Session Beans in EJB or the like.

While only two clients are illustrated in FIG. 1, it is understood many more clients can be arranged to make requests to system 12 through Facade 13. Further, facade 13, in addition to passing the requests out as specific transactions, can receive and store the requests until the specific transaction can be created. A transaction Manager (Trx Mgr) 16 can be arranged to manage a presently executed transaction according to a transaction start/end notice received from facade 13.

Each transaction accesses and operates at least one specific application or business logic. The application (business logic) can issue a log/trace output request to logger/tracer 17. As such a request is generally made without considering output timing, logger/tracer 17 can include a memory or buffer so as to store or buffer the log/trace from the application instead of immediately outputting it. Log/trace scheduler 18 can comprise a computing device structured and arranged to estimate optimized output timing to write traces based upon transaction characteristics. The computing device of log/trace scheduler 18 can be formed, e.g., to include any general purpose computing article of manufacture capable of executing computer program code installed thereon (e.g., a personal computer, server, handheld device, etc.). However, it is understood the computing device of log/trace scheduler is only representative of various possible equivalent computing devices that may perform the processes described herein. To this extent, in embodiments, the functionality provided by the computing device can be implemented by a computing article of manufacture that includes any combination of general and/or specific purpose hardware and/or computer program code. In each embodiment, the program code and hardware can be created using standard programming and engineering techniques, respectively.

Log/trace scheduler 18 can also include a processor device to execute computer program code, which may be stored in a memory within log/trace scheduler 18 or in the internal or externally accessible memory of architecture 12. While executing computer program code, the processor can read and/or write data to/from the log/trace scheduler memory, the internal or external memory and/or an input/output interface. A bus can provide a communications link between each of the components in the computing device of log/trace scheduler 18. The input/output interface can include any device that enables interaction with the computing device or any device that enables the computing device to communicate with one or more other computing devices using any type of communications link.

The timing optimization can be determined by a score evaluation algorithm, and settings for the algorithm can be set or adjusted by policy 19, which can be under the control of an operator, such as a system administrator. When the score ascertained by the algorithm is within the optimization limits of policy 19, log/trace scheduler 18 can instruct logger/tracer 17 of the optimum time to output the log/trace from its associated memory or buffer to file 23. As a result of the application's log/trace output request, a log output may be performed by logger 17′ and a trace output may be performed by tracer 17″. Thus, this data can be written separately or at the same time. File manager 20 can be arranged for the input/output of other files, while database manager 21 can be arranged for database input/output, and external call manager can be arranged for external communication with MQ or the like.

A practical example of the embodiment shown in FIG. 1, is provided for a financial transaction such as a deposit. Assuming client A deposits money into an automated teller machine (ATM), a “deposit” transaction request is forwarded from the ATM to the Core banking system, e.g., in the backend host. In this regard, all requests from clients are forwarded or passed to the backend application (i.e., a Core banking system) through facade 13. If the request from client A is passed to facade 13, then facade 13 notifies transaction manager 16, which generates an instance of the transaction (e.g., named “transaction-1”) and stores basic information such as transaction start time, transaction ID, account number used, money of transaction etc. A corresponding business logic can then be called or accessed for the requested transaction. In this example, the “deposit” transaction logic will be called for transaction-1 from client A. During the business logic processing, a file may be read or written. In such a case, the request can be sent to File Manager 16 from each business logic, then File Manager 16 will read or write to/from file 23. Similar actions can be taken by database manager 21 and external manager 22. If a database read or write is needed, the request can be sent to database manager from the business logic, then database manager read or write from/to DB.

In the “deposit” example, the current account information may be read from an account table in the database, then the transaction journal can be inserted and Account Table can be updated with the latest balance. Tracer 17″ and logger 17′ are the components that can actually write to file 23 in response to the business logic's request to write trace/log to file 23. The present invention provides a manner in which the writing of the trace/log to file 23 is optimized through the score determined in log/trace scheduler 18 according to policy 19. In this regard, the policy 19 can be predefined by a system administrator. Based upon policy 19, log/trace scheduler 18 can calculate a score, which considers the operating system (OS) 24 to obtain a current disk utilization and utilizes transaction manager 16 to obtain a transaction score. Transaction manager 18 can calculate the transaction score, in cooperation with file manager 20, database manager 21 and external manager 22.

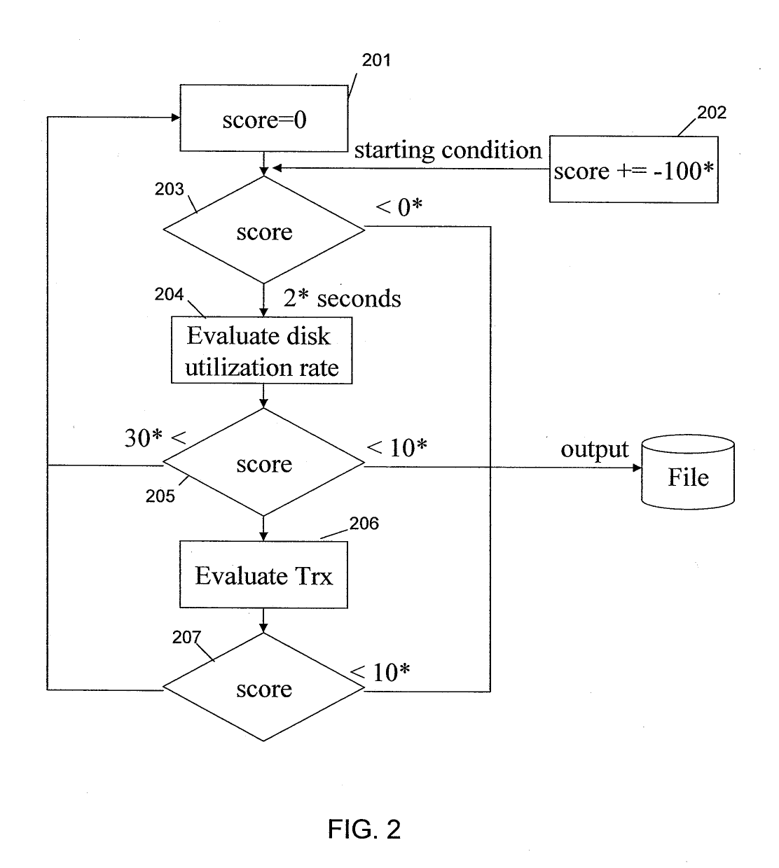

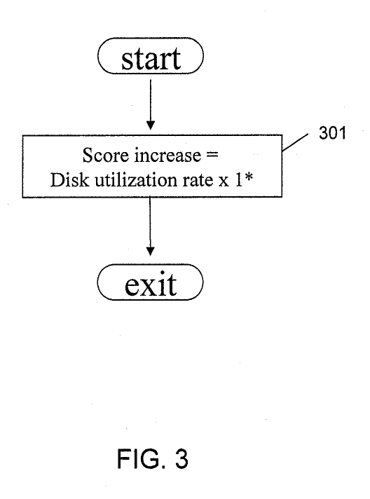

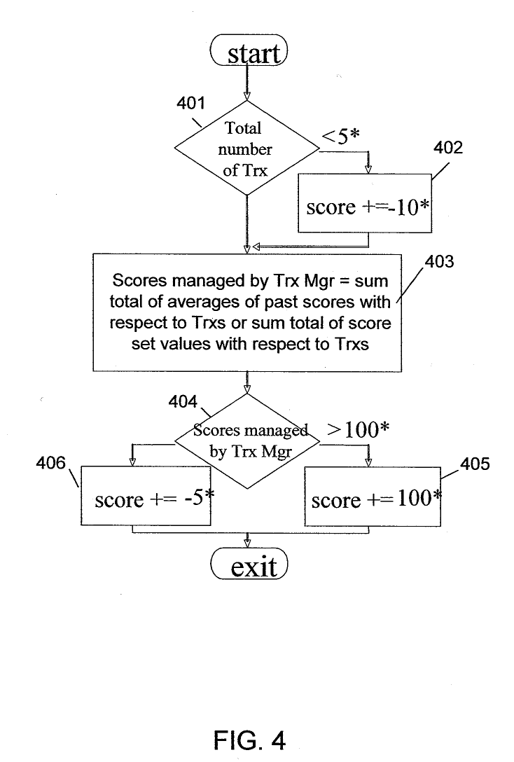

An exemplary embodiment of the calculation of the transaction score by the log/trace scheduler is illustrated in FIG. 2. The values shown in the flow diagram (an in other pending figures of the instant application) with an asterisk correspond to the values set by the system administrator in the policy. Initially, the score can be set to 0 at step 201, and, in the event of an error (at any time), the score can be increased by −100 at step 202. Thereafter, a determination may be made at step 203 whether the score is less than 0. When the score at step 203 is less than zero, i.e., when an error has occurred, the logger/tracer is instructed to output the log/trace to the file. When the score is not less than 0, the process can wait a predefined period, e.g., 2 seconds, and then may evaluate a disk utilization rate, as more fully discussed with regard to FIG. 3, to adjust the score at step 204. At step 205, the score is again monitored. When the score at step 205 is less than 10, the log/trace is output to the file, and, when the score at step 205 is more than 30, the process returns to step 201 and resets the score to 0. When the score at step 205 is between 10 and 30, the transaction is evaluated, as more fully discussed with regard to FIG. 4, to adjust the score at step 206. At step 207, the score is again monitored, such that, if less than 10, the log/trace is output to the file. Otherwise, the process returns to step 201 and the score is reset to 0.

As discussed above with regard to step 204, the score can be adjusted as a result of an evaluation of the disk utilization rate. In this regard, the log/trace scheduler can obtain the disk utilization rate from the operating system, and convert this information into the score. As shown in the flow diagram of FIG. 3, the score can be increased by a value corresponding to (disk utilization rate*1). Then, the process proceeds to step 205 in FIG. 2. It is noted, this score adjustment can only be executed when a disk utilization rate is obtained.

As referred to in step 206, FIG. 4 depicts a flow diagram for adjusting the score based upon a transaction evaluation. Moreover, it is noted the transaction manager manages a score with respect to each transaction independently of the log/trace scheduler, and these scores are utilized in adjusting the score in the log/trace scheduler. According to the exemplary flow diagram, the total number of transactions is captured at step 401, and, if the total is less than 5, the score can be increased by −10 at step 402. Otherwise, the process proceeds to step 403, where the transaction scores managed by the transaction manager are equal to either the sum of averages of past scores with respect to transactions or the sum of score set values with respect to transactions. At step 404, the transaction scores managed by the transaction manager are determined. When the transaction score is greater than 100, the score can be increased by 100 at step 405. Otherwise, the score can be increased by −5 at step 406. The process can then proceed to step 207 in FIG. 2.

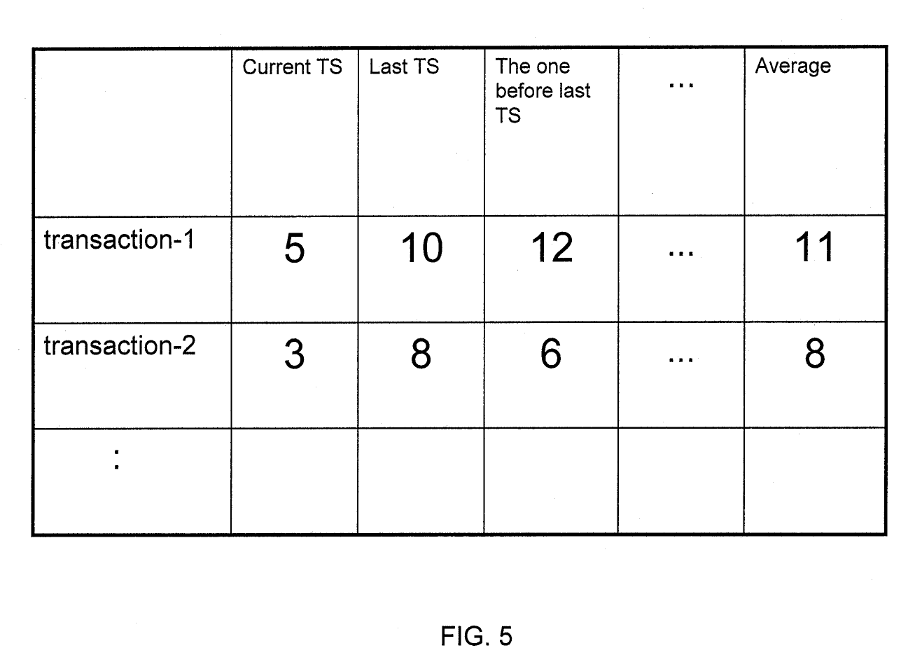

Transaction scores managed by the transaction manager can be determined a number of ways. By way of example, the policy can define a setting as to whether the transaction score is an average of past several scores computed during execution or a value set by the system operator. When the transaction scores managed by the transaction manager are based on the average, an exemplary table, as illustrated in FIG. 5 can be utilized. The table in FIG. 5 shows the current transaction score, previous transaction score, second previous transaction score and average value for each transaction managed by the transaction manager. In the table, the average value is the average of past transaction scores, exclusive of the current transaction score, and the current transaction score becomes the previous transaction score at the completion of transaction. The policy determines the number of past transaction scores to be held. Thus, the transaction manager manages a transaction score with respect to each transaction independently of Log/Trace Scheduler, and the transaction scores can be a number based on scoring times or based on time. The policy sets which manner of scoring is to be utilized.

When the policy sets the transaction scores on a number based on scoring times, the transaction manager can change the current transaction score with respect to each transaction according to a notice from the file manager/database manager/external manager. At the beginning of a transaction, the transaction score can be set to 0. Upon notice from the file manager, the score can be increased by 1 in the case of input/output of anything other than Log/Trace. Upon notice by the database manager, the transaction score can be increased by −1 if the database exists outside, and can be increased by 1 if the database exists inside. Upon notice from the external manager, the transaction score can be increased by −1. The values of increase/decrease to the score can be set by the system administrator in the policy.

When the policy sets the transaction scores based on time, the transaction manager can compute the current transaction score with respect to each transaction according to a notice from the file manager. At a beginning of a transaction, the transaction score can be set to 0. When the time required for file input/output (exclusive of log/trace) divided by the time for all transactions is less than 0.10, the transaction score can be increased by 1, i.e., new transaction score=transaction score+1. When the time required for file input/output (exclusive of log/trace) divided by the time for all transactions is less than 0.50, the transaction score can be increased by 5, i.e., new transaction score=transaction score+5. When the time required for file input/output (exclusive of log/trace) divided by the time for all transactions is greater than or equal to 0.50, the transaction score can be increased by 10, i.e., new transaction score=transaction score+10. the same things can be defined for the case in which a notice is originated from the database/external manager. The values of increase/decrease to the score can be set by the system administrator in the policy.

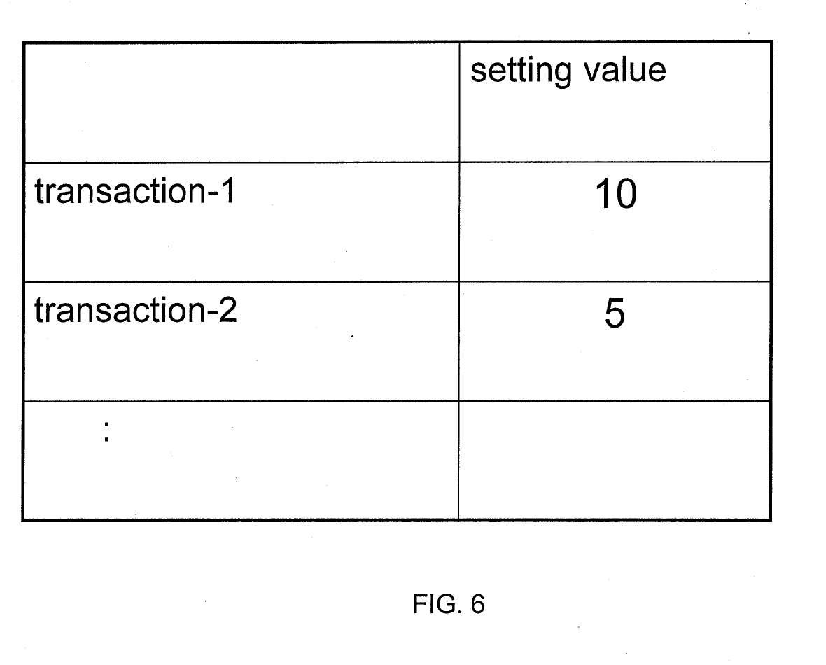

When the scores managed by the transaction manager are based on set values by the system administrator, an exemplary table, as illustrated in FIG. 6 can be utilized. The table in FIG. 6 shows a value set by the system administrator for each transaction.

With regard to the scoring, it is noted there can be maximum and minimum values in evaluation, and these values can be pre-registered by the system administrator. Moreover, it is contemplated the system itself can dynamically change based upon a situation, which can allow more effective timing of output

In this regard, in the conventional trace outputting method, as the transaction volume grows, the score also grows, so that, more often than not, the trace may not be written until or after the buffer capacity has been reached, which is contrary to the above-noted features of the invention. To avoid this drawback, the invention can provide for changing the minimum value of scoring when the transaction volume gets high.

According to the invention, this change of minimum value can be effected in a number of manners. By way of example, the administrator may pre-register a pattern of the change, i.e., based upon the trend of transaction volume in a day, the time of change (for high volume transaction) and the changed value can be pre-registered to accommodate for known or anticipated volumes. Further, if the nightly batch is performed and this optimization is not so effective, this time can be pre-registered so this approach is not applied.

According to the invention, the system itself can decide the changed minimum value and when to apply it. For example, if in the algorithm the situation “number of transaction>100” is repeated several times, e.g., 10 times in a row, the system can increase the minimum value of scoring to avoid this repeating.

The invention can take the form of an entirely hardware embodiment or an embodiment containing both hardware and software elements (any of which is referred generally as “file management program”). The hardware and software elements include a computer infrastructure configured to implement the functionality of the present invention. The computer infrastructure may take the form, for example, of system 10 in FIG. 1. The software elements may be firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

In embodiments, a service provider, such as a Solution Integrator, could offer to perform the processes described herein. In this case, the service provider can create, maintain, deploy, support, etc., a computer infrastructure that performs the process steps of the invention for one or more customers. In return, the service provider can receive payment from the customer(s) under a subscription and/or fee agreement.

What is claimed:

1. A method for managing data write timing, comprising:
selecting a policy composed of optimizing limits;
inserting the selected policy into a score algorithm;
running the score algorithm in response to a request to write data to determine a score; and
writing the data to a file when the score is within the optimizing limits.

2. The method in accordance with claim 1, wherein the optimizing limits are selected from at least one of disk I/O conditions, number of transactions during operation, weights (scores) for corresponding types of transactions, and transaction history.

3. The method in accordance with claim 1, wherein the data comprises at least one of traces and logs.

4. The method in accordance with claim 1, wherein the optimizing limits are selected to write the data to the file based upon one of disk status and transaction profiling.

5. The method in accordance with claim 1, wherein the score algorithm is run in a log/trace scheduler.

6. The method in accordance with claim 1, wherein the score algorithm updates a value of the score based upon an evaluation of disk utilization rate of the operating system.

7. The method in accordance with claim 1, wherein the score algorithm changes the score based upon a transaction score in a transaction manager.

8. The method in accordance with claim 7, wherein the transaction scores correspond to one of a sum of averages of past scores with respect to transactions or to a sum of score set values with respect to transactions.

9. The method in accordance with claim 1, wherein the process operates in a client-server system.

10. The method in accordance with claim 9, wherein the client-server system includes transaction characteristics.

11. The method in accordance with claim 1, wherein the steps of claim 1 are provided by a service provider on a fee and/or subscription basis.

12. The method in accordance with claim 1, wherein a service provider at least one of creates, deploys, maintains, supports an infrastructure for implementing the steps of claim 1.

13. A system for managing data write timing, comprising:
a policy storage unit structured and arranged to store optimizing limits;
a log/trace scheduler coupled to the policy storage unit and comprising a score algorithm;
the log/trace scheduler structured and arranged to receive a write data request from an application; and
at least one of a logger or tracer coupled to receive from the log/trace schedule an authorization to write the data,
wherein the log/trace scheduler authorizes the writing of data when a score from the score algorithm is within the optimizing limits.

14. The system in accordance with claim 13, wherein the optimizing limits are selected from at least one of disk I/O conditions, number of transactions during operation, weights (scores) for corresponding types of transactions, and transaction history.

15. The system in accordance with claim 13, wherein the process operates in a client-server system.

16. The system in accordance with claim 15, wherein the client-server system includes transaction characteristics.

17. The system in accordance with claim 13, wherein the data comprises at least one of traces and logs.

18. The system in accordance with claim 1, wherein the score algorithm receives an evaluation of disk utilization rate of the operating system to update the score.

19. The system in accordance with claim 1, further comprising a transaction manager coupled to the log/trace scheduler, wherein the transaction manager stores a transaction score utilizable by the algorithm to update the score.

20. A computer program product comprising a computer usable medium having readable program code embodied in the medium and including at least one component to:
receive optimizing limits of a policy;
insert the optimizing limits into a score algorithm;
run the score algorithm in response to a request to write data to determine a score; and
write the data to a file when the score is within the optimizing limits.
